(19) United States
(12) Patent Application Publication
(10) Pub. No.: US 2006/0085698 A1
(43) Pub. Date: Apr. 20, 2006

(54) Synchronization mechanism for tools that drive UI-based applications

(75) Inventor: Dmitri A. Klementiev, Redmond, WA (US)

Correspondence Address: KLARQUIST SPARKMAN LLP, 121 S.W. SALMON STREET, SUITE 1600, PORTLAND, OR, 97204, US

(73) Assignee: Microsoft Corporation, Redmond, WA (US)

(21) Appl. No.: 10/966,678

(22) Filed: Oct. 15, 2004

(51) Int. Cl. G06F 11/00

(52) U.S. Cl. 714/55

(57) ABSTRACT

Various new and non-obvious apparatus and methods for synchronizing a request to perform a target action on a user interface element within a user emulation test program are disclosed. The disclosed exemplary apparatus and methods should not be construed as limiting in any way. One of the disclosed embodiments is used when a user emulation test program is unable to access at least one background thread, or is working in an environment where at least one thread may essentially be in a busy state. The method comprises choosing a target element, establishing time-out criteria, a calling entity invoking a target action to be performed on the target element, attempting to perform the target action on the target element, and returning control to the calling entity when either the target action is successfully performed on the target element or when the previously-mentioned time-out criteria is met, in which case a synchronization error condition is generated. In one embodiment, attempting to perform the target action can consist of: waiting until a window associated with the target element is ready for user input; the thread associated with the target element is in the wait state and the reason for this state is wait for user input; or waiting until two readings of a performance counters associated with the target process are essentially similar, and then attempting to perform the target action. Also, the target action can be attempted, in some embodiments, to be performed repeatedly until it is either successfully performed or until the time-out criteria is met.

### COPYRIGHT AUTHORIZATION

A portion of the disclosure of this patent document contains material, which is subject to copyright protection. The copyright owner has no objection to the facsimile reproduction by any one of the patent disclosure, as it appears in the United States Patent and Trademark Office patent files or records, but otherwise reserves all copyright rights whatsoever.

### TECHNICAL FIELD

This invention relates generally to the testing of software applications, and more particularly to the ensuring that a graphical user interface element (UI element) is ready for interaction.

### BACKGROUND

Almost, if not all, modem operating systems are multi-threaded. Furthermore, more and more systems allow concurrent applications, each with their own threads, to be running using multi-processors. At the same time, the rise of graphical user interface applications which use the threads, have allowed users to interface with both the operating system and whatever applications may be running on it in an astounding number of ways. For example, multiple applications, each application with multiple windows, can be running simultaneously. The user is presented with an almost unlimited number of paths through the feature sets. Using the mouse or keyboard input the user can impulsively switch from window to window, and treenode to test box.

When testing applications with graphical user interfaces (GUIs), a tester must take both the user-driven nature of GUIs and the many choices offered to the user at any time-the multiple paths problem-into account. However, sometimes such needs are contradictory. For example, one solution to the multiple paths program is to automate the GUI testing. As automated testing programs can be run at computer speed, many more pathways through a GUI can be tested than is reasonable when using human testers. But, computers and humans each have their own strengths, and one thing humans excel at is the ability to discern the difference between a minor hiccup in a program and an actual code bug.

Due to the complex interaction between the many threads running on even a modest GUI application and the interaction between those threads, the operating system threads, and the threads of any other applications running, certain actions may fail not because of any underlying problems with the software, but merely because of timing issues. A human tester will most likely ignore a mouse click that does not select an object, but an automated tester will record such an event as a failure; a thorny test error that is impossible to recreate and difficult to understand.

Referring to prior art FIGS. 1A and 1B, a portion of two tree nodes, each with 1000 children (102A, 104A) are shown in their unexpanded version in FIG. 1A. Turning to FIG. 1B, at time T1 (102B) keyboard input (user or user emulation program) instructs node 102A to expand. At time T2 (104B), node 104A receives a request to expand. At time T3 (106B), the node (102A) finishes expanding. In many operating systems, the thread associated with both nodes 102A and 104A is in a “busy” state during the entire expansion of 102A, that is between times T1 (102B) and T3 (106B) and therefore, any user requests between times T1 and T3 will be ignored, such as a request to expand node 104A—the user clicks on node 104A, but nothing happens. The expansion of node 104A fails due to a synchronization problem. When a person is using the interface this failure is probably just annoying, as the person will likely just try the expansion again. However, when an automatic testing program repeats the same set of actions, the failure of treenode 104A to expand will be treated as a testing failure, and recorded as such in a testing log. Such failures, as they are the result of complex interactions between background and foreground threads, are very difficult to repeat, and so create problems for testing verification.

Referring to prior art FIG. 1C, a control, “control window” populated with arrayed items (102C) is shown. Consider the pseudocode implemented in an automated testing environment:

Bring up control window 100 ( )

Select(Item 102C(1));

This code will often fail because the control window takes awhile to draw all of the arrayed items, such that the Select code line is run before Item 102C(1) appears on the window, and thus, it cannot yet be selected. With reference again to FIG. 1B, when the first line of code begins processing (Bring up control window 100C( )) the thread associated with control window 100C gains control of the processor at time T1, and is not available for any other actions, such as to select a specific item in the thread, until time T3.

The length of time between T1 and T3 is very difficult to predict. Developers, when presented with the problem of timing failures, have a tendency to solve it by forcing a program to sleep for a long enough period of time that the operating system will have time to perform the action. One or two such sleep statements may not cause a problem, but they very quickly add up and can cause serious degradation in program execution time. Developers also tend to overestimate the amount of time necessary to sleep, for fear of not waiting long enough, so sleeps of as long as 10 seconds are occasionally seen. Furthermore, a sleep of appropriate length on one machine may be much too short or much too long on another that runs at a different speed.

It can be seen that when a function with an embedded sleep statement is called by another function that also contains a sleep, the time required to execute the program can quickly cascade out of control. For example, the time taken to run regression tests has been shown to triple with the incorporation of sleeps to solve the synchronization problem described above.

One prior art solution comprises locating the target test interaction within a message queue, and waiting until the target test interaction has been processed, at which point the user is notified. However, due to the interaction with uncontrollable background threads, this is reliable only about half of the time.

Another prior art solution involves setting the “WH_FOREGROUNDIDLE” hook, a procedure that is called when an application's foreground thread is about to become idle. However, using this requires that the test code be loaded into the process space of the target application, often undesirable, as it may change the parameters of the target process and can lead to the introduction of new bugs in the target application caused by the testing process itself. It should go without saying that a testing application should not be the source of errors that appear to be caused by the program under test.

### SUMMARY

As described herein, various new and non-obvious apparatus and methods are disclosed to ensure that a UI element is ready to perform a requested action and this action is performed successfully. If the requested action is not performed, an error condition is generated in such a way that a test program knows the nature of the error. The disclosed exemplary apparatus and methods should not be construed as limiting in any way. Instead, the present disclosure is directed toward novel and non-obvious features and aspects of the various disclosed embodiments, alone and in various combinations and subcombinations with one another. The methods are not limited to any specific aspect, feature, or combinations thereof, nor do the disclosed methods require that any one or more specific advantages be present or problems be solved.

In one implementation, a UI element is found, and a requested action that is to be performed on the UI element is chosen. Quite often, the requested action is that the UI element is selected, but it may be any action that can be performed by a user emulation test program. A time-out criterion is determined that will generate an error message informing the calling program that there has been a failure due to a synchronization problem. A common criterion is that too much time has been spent waiting for the action to be performed. Then, the requested action is attempted to be performed. If the action is unable to be performed, then the time-out criterion is checked; if it has not been satisfied, the program sleeps, and then attempts to perform the action again.

In one implementation, when attempting to perform the requested action, the UI element's associated window and thread are determined. Then, prior to attempting to perform the requested action, the program pauses until the associated window is ready to accept user input. For instance, this may comprise pausing until the thread associated with the window is the foreground thread, by pausing until the window associated with the object is enabled, or by pausing until the window associated with the object has focus.

To improve upon this implementation, performance counters associated with the target process can be checked at two different times. If the two time-spaced readings are essentially the same, then it is assumed that the target process is ready for a user input and the action is attempted to be completed. If the values of the two readings are too far apart, then, the process pauses, and—the cycle repeating—again takes the two readings.

To improve the synchronization ability still further, the action is requested to be performed, then a check is made to determine if the performance occurred. If not, the process pauses, and another attempt is made to perform the action. This process continues until either the action is successfully performed, or the time-out criterion is met. If the time-out condition is met, an error condition is generated, which allows the test program to determine that the failure was the result of a synchronization problem.

In an exemplary embodiment, several different pause types are provided. For example, the process may pause for a specific time, until an event occurs, or may return immediately.

Additional features and advantages will be made apparent from the following detailed description of various embodiments that proceeds with reference to the accompanying drawings.

### BRIEF DESCRIPTION OF THE DRAWINGS

FIG. 1A is a depiction of two unexpanded nodes.

FIG. 1B is a depiction of a timing diagram relating to expanding nodes.

FIG. 1C is a depiction of a window populated with many items.

FIG. 2A is a block diagram of a computer system.

FIG. 2B is a block diagram of a computer system that illustrates some of the aspects described herein.

FIG. 3A is a flowchart of an exemplary method for ensuring that a UI element has performed a requested action.

FIG. 3B is a flowchart of an exemplary method that extends some of the method acts described in FIG. 3A.

FIG. 4 is a flowchart of an exemplary method that extends some of the method acts described in FIGS. 3A and 3B.

FIG. 5 is flowchart of another exemplary method that extends some of the method acts described in FIGS. 3A and 3B.

FIG. 6 is a flowchart of another exemplary method that extends some of the method acts described in FIGS. 3A and 3B.

FIG. 7 is a flowchart of an exemplary method for ensuring that a UI element will perform an action that extends some of the aspects of the method acts shown in FIGS. 4, 5, and 6.

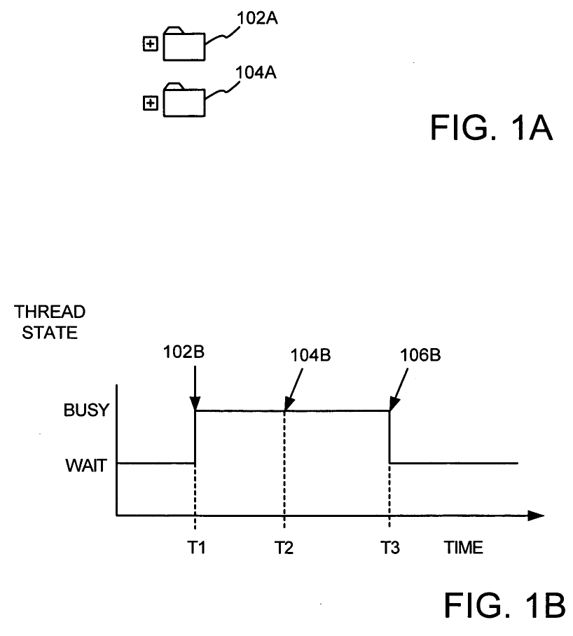

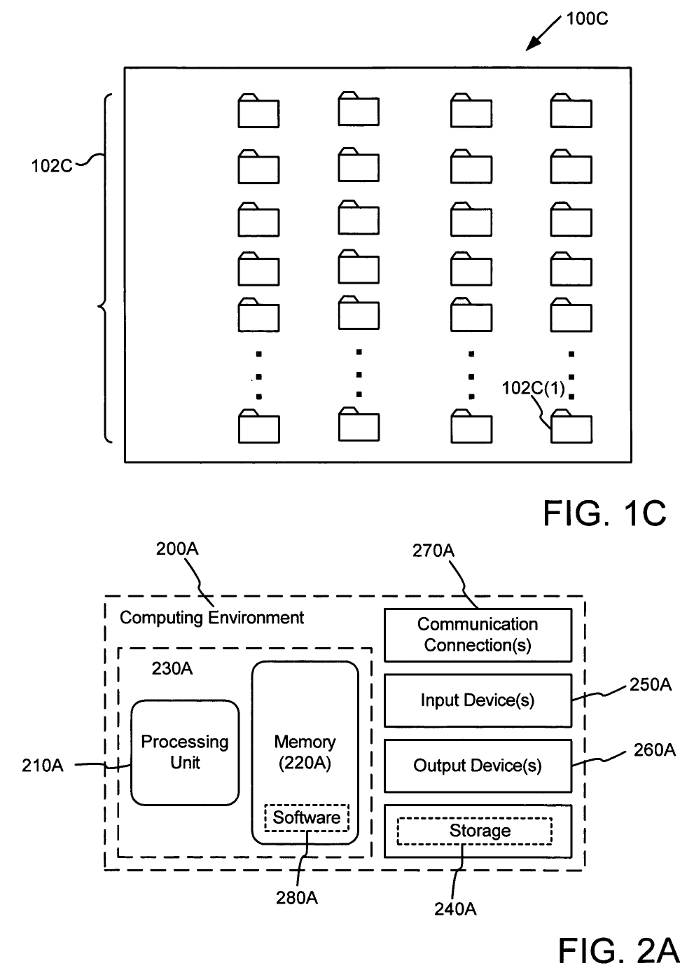

### DETAILED DESCRIPTION

Described embodiments relate to techniques and tools for synchronizing a test application with a target application which the test application does not control. The various techniques and tools can be used in combination or independently.

### Computing Environment

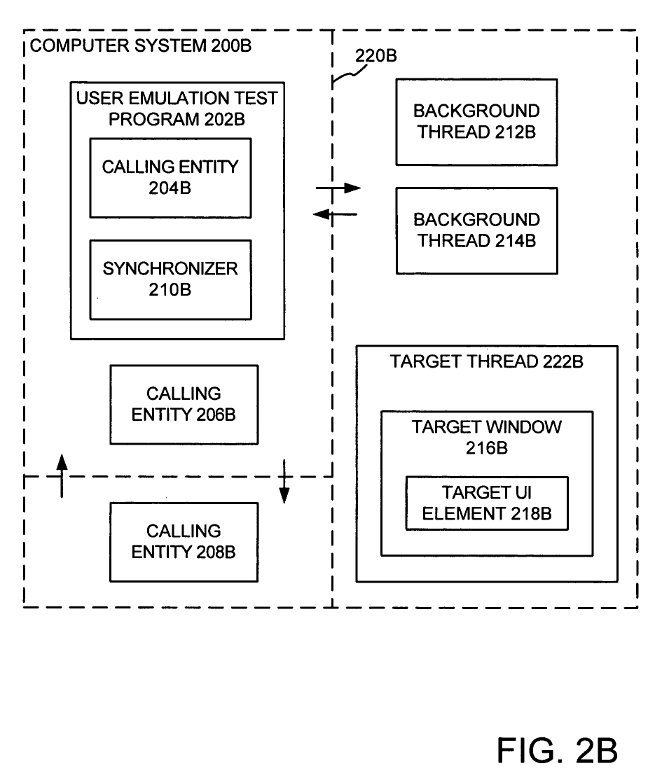

FIG. 2A illustrates a generalized example of a suitable computing environment (200A) in which several of the described embodiments may be implemented. The computing environment (200A) is not intended to suggest any limitation as to scope of use or functionality, as the techniques and tools may be implemented in diverse general-purpose or special-purpose computing environments.

With reference to FIG. 2A, the computing environment (200A) includes at least one processing unit (210A) and memory (220A). In FIG. 2A, this most basic configuration (230A) is included within a dashed line. The processing unit (210A) executes computer-executable instructions and may be a real or a virtual processor. In a multi-processing system, multiple processing units execute computer-executable instructions to increase processing power. The memory (220A) may be volatile memory (e.g., registers, cache, RAM), non-volatile memory (e.g., ROM, EEPROM, flash memory, etc.), or some combination of the two. The memory (220A) stores software (280A) implementing a method and system to make a UI element visible.

A computing environment may have additional features. For example, the computing environment (200A) includes storage (240A), one or more input devices (250A), one or more output devices (260A), and one or more communication connections (270A). An interconnection mechanism (not shown) such as a bus, controller, or network interconnects the components of the computing environment (200A). Typically, operating system software (not shown) provides an operating environment for other software executing in the computing environment (200A), and coordinates activities of the components of the computing environment (200A).

The storage (240A) may be removable or non-removable, and includes magnetic disks, magnetic tapes or cassettes, CD-ROMs, DVDs, or any other medium which can be used to store information and which can be accessed within the computing environment (200A). The storage (240A) stores instructions for the software (280A) implementing the synchronizer.

The input device(s) (250A) may be a touch input device such as a keyboard, mouse, pen, trackball, a voice input device, a scanning device, or another device that provides input to the computing environment (200A). For audio or video encoding, the input device(s) (250A) may be a sound card, video card, TV tuner card, or similar device that accepts audio or video input in analog or digital form, or a CD-ROM or CD-RW that reads audio or video samples into the computing environment (200A). The output device(s) (260A) may be a display, printer, speaker, CD-writer, or another device that provides output from the computing environment (200A).

The communication connection(s) (270A) enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The techniques and tools can be described in the general context of computer-readable media. Computer-readable media are any available media that can be accessed within a computing environment. By way of example, and not limitation, with the computing environment (200A), computer-readable media include memory (220A), storage (240A), communication media, and combinations of any of the above.

The techniques and tools can be described in the general context of computer-executable instructions, such as those included in program modules, being executed in a computing environment (200A) on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment.

Automated testing of GUIs often produces spurious failures due to synchronization problems with the myriad threads running at any given time on an operating system. One embodiment disclosed herein is an improved method to synchronize UI elements specifically to ensure that a target UI element will not fail when attempting to accept user input.

### Definitions

As used herein, the terms control, element, item and object are interchangeable, and also encompass ideas such as container and component. The idea behind all such listed words embraces any viewable object, such as listboxes, combo boxes, tree structures, radio buttons, calendars, windows, forms, panels, and combinations thereof. New implementations of viewable objects are being constantly created and the embodiments disclosed embrace viewable elements that have not been formally given a name.

The meaning of the term synchronization as used here is slightly different from the common meaning of this term. Usually, the term synchronization assumes a 100% guaranteed result, that is, that the given objects are synchronized or that an error state occurs. For instance, when Windows API call WaitForSingleObject( ) is called, it will either return when the object enters the desired state or when a time-out interval has lapsed. That is, it always works or throws a known error condition unless the hardware malfunctions. In the case of UI-based applications, however, many operating systems provide no mechanisms that can be used to synchronize two or more UI elements. This allows synchronization errors to occur that are otherwise unmarked. We use the term synchronization here to describe a mechanism or a combination of different mechanisms where a small failure rate is acceptable when the reason for the failure is almost always known and communicated. The term “select item” refers to a user interaction or to a test program that mimics user interaction with a UI element using a mouse, a keyboard, or another user input device.

### Overview

To ensure that a user emulation test program either successfully synchronizes with a target program or an error message is generated, which indicates that an apparent failure was due to a synchronization problem, the following systems and processes are provided.

With reference to FIG. 2B, the computer system (200B) includes a user emulation test program (202B) used to test applications which includes UI elements. The user emulation test program may reside on the same computer as the target UI element (218B) or may reside on a different computer that has access to the target UI element through a communications connection such as an intranet, the internet, or some other communications system. The dotted line (220B) represents the possibility of such an external connection. This most basic configuration of the user emulation test program (202B) contains a synchronizer (210B) which synchronizes a request by the user test emulation program (202B) with an action to be performed on a target UI element (218B). The user test emulation program may also contain a calling entity (204B, 206B,) which initially requests the action to be performed on the target UI element. This calling entity (204B), in some embodiments, can be located within the user test emulation program, within the same computer (206B), or in a different computer (208B) connected by a communication link.

In some embodiments, the user emulation test program (202B) should not verify states of all background threads (212B, 214B) since some of them may always be in the busy state and a synchronization mechanism may always raise a time-out error condition. The target UI element (218B) has, as a direct ancestor, a window (216B) associated with it. When this window is disabled, the target element will also be disabled. Similarly, the ancestor window must, at a minimum, have foreground focus for the target element to be able to be selected. The target element may itself be a window owned by another ancestor window.

The ancestor window (216B) of the target element (218B) has an associated thread (222B). This thread, in some embodiments, can be referred to as an ancestor of the window (216B) and of the UI element (218B).

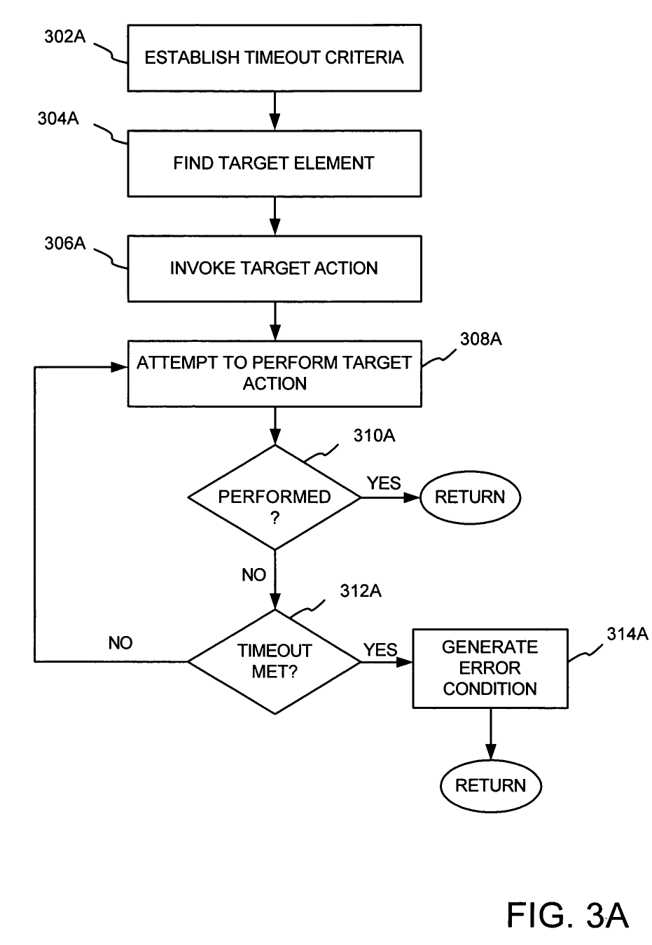

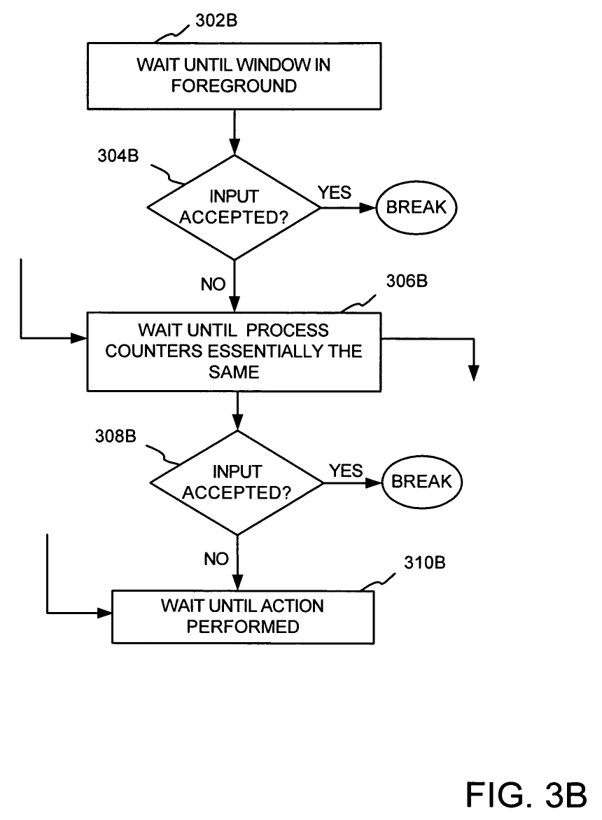

The computer environment (200B) referred to above can be more fully understood with reference to FIGS. 3A and 3B. With reference to FIG. 3A, initially, some time-out criterion (or criteria) is chosen, as can be seen at process block 302A. Even though a series of synchronization processes are provided, occasionally due to unanticipated events, synchronization will still be unable to be achieved. In such a case, a time-out criterion must be established to ensure that the program does not spend too much time on a fruitless endeavor, and to ensure that an error message is generated that indicates that the error was caused by a synchronization problem, rather than by any underlying condition in the program that is being tested.

An exemplary embodiment is described in the flowchart of FIGS. 3A and 3B. It should be apparent to those skilled in the art that the the flowchart shown in FIGS. 3A and 3B is not the only way to perform the given process, and is for illustrative purposes only. For example, certain acts described may be omitted in particular embodiments, and certain acts may be performed in an order different than that shown. At process block 304A, a UI element is chosen Anything that can be seen on the screen can be the UI element. At process block 306A, a target action to be performed on the UI element is determined. This might be something as simple as selecting the element, or may involve a more complex action.

Once an element, a time-out criterion, and an action for the element are selected, the action is carried out, as can be seen at process block 308A. But, it is not assumed that the action was successful. Rather, the process checks to determine if the action was carried out successfully. If it was, the process returns control to the calling entity. If the action was not successful, then the time-out criterion is checked. If the time-out criterion has been met, then an error condition is generated, as shown at process block 314A. The result might be an error message sent to a predefined location, a notation in a log, or another method of indicating that a synchronization error has occurred.

If the time-out criterion has not been met, then repeated attempts are made to perform the action either until the time-out criterion is met or until the action is successfully performed. This ensures that even though not every action may be successful, there will be no (or very few) mysterious error conditions caused by synchronization failures.

In certain embodiments, to ensure that a UI element has successfully performed a desired action, with respect to FIG. 3B, as shown at process block 302B, the test emulation program waits until the window associated with a user test element is in a state to accept user input. This might mean that, in some embodiments, the window is in the foreground; in other embodiments, that the window has focus; and in yet other embodiments that the thread associated with the window is the foreground thread. After the window has been verified to be in the foreground, the program attempts to make the UI element perform the action, as shown at process block 308B. If it succeeds, the process terminates.

If the user action is not performed, then the program waits until performance counters associated with the the target process have substantially the same readings at two different times, as shown at process block 306B. Once the performance counters have similar-enough readings it is assumed that the user input element window (or a relative) is ready for a user input, and the program again attempts to make the UI element perform the action.

If the attempt fails again, as shown at process block 310B, the action is again attempted to be performed, and is then checked to see if the performance was successful. If the attempt is not successful, it pauses, and tries again until the action is performed or until some time-out criteria is met.

### Specific Embodiments

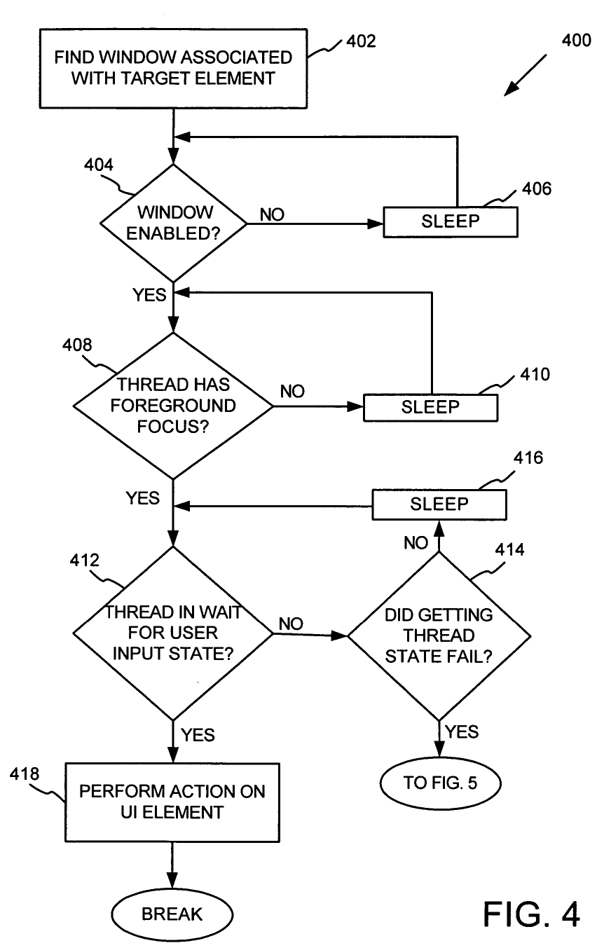

FIG. 4 is a flowchart (400) of a basic procedure for ensuring that a UI element will successfully accept user input that expands upon the methods referred to in FIGS. 3A and 3B. The flowchart (400) shows only one exemplary embodiment of ensuring that a target UI element will accept user input and should not be construed as limiting in any way.

At process block 402, the window associated with a target UI element is determined. This window can be referred to as an ancestor or a direct ancestor window of the target UI element. In some operating systems, when a displayable UI element is created, a window handle is also created. Among other functions, this window handle identifies the visual aspects of the object to the operating system and it also associates the object with its specific window. If the target UI element does not possess a window handle, then the closest ancestor with a window handle is located, and the window associated with that handle is considered the target element's window.

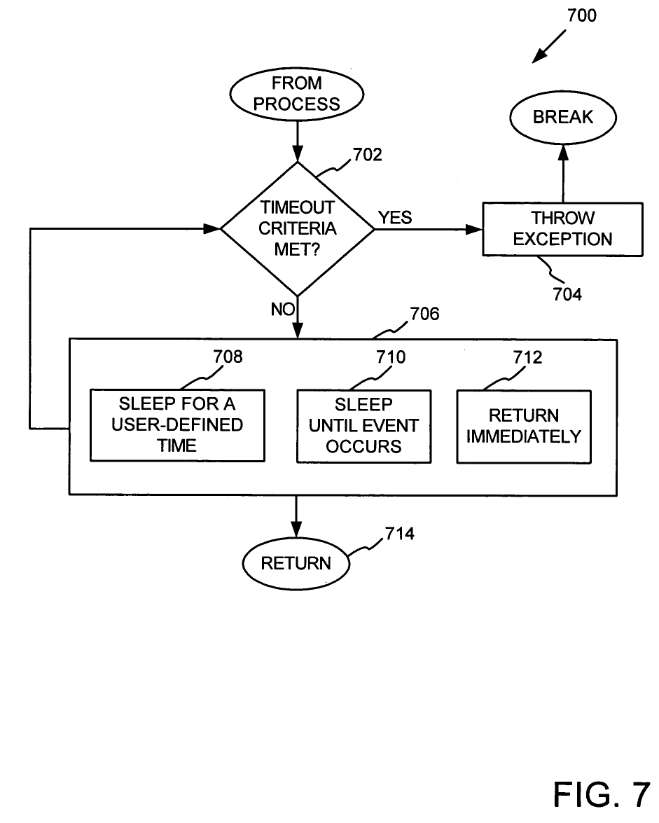

At process block 404, it is determined if the window which was located in process block 402 is enabled. If so, then the process continues at process block 408. If not, the process continues at process block 406. When a window is enabled, it is able to receive keyboard/mouse focus; it can be selected. Disabled windows ignore all attempted input. They cannot be selected by a user (or a user emulation test program) and are often, though not always, visually distinct from enabled windows; a common visual marker is that they are grayed. At process block 406 the process sleeps; this process is explored more thoroughly with reference to FIG. 7. In an exemplary embodiment the sleep time is around 100 ms. After sleeping, enablement is again checked at process block 404.

At process block 408, it is determined if the window has foreground focus. If it does, then the process continues at process block 412. If not, the process is continued at process block 410, where the process first sleeps, and then again checks for foreground focus. Threads are, in many operating systems, the basic object that executes instructions on a processor. In such systems, each window has a thread associated with it. In multi-threaded operating systems, foreground focus ensures that the thread that created a specific window is the foreground thread; that is, the thread's windows are on top of the screen in the sense that they are not behind or overlapped by other application windows, and they can be selected by a user.

At process block 412, the window thread is checked to see if it is in a “wait for user input” state. If so, then the process continues at process block 418. If not, the process continues at process block 414. Each thread can be in many states, one of which, commonly, is “waiting”. Other common states are “running”, “ready”, “standby”, etc. The waiting state, typically, is composed of many sub-states, one of which is “waiting for user input” which is sometimes also called “waiting for a user request”. In Windows, the processor counter “Thread State” has the value 5, “waiting”; and the processor counter “Thread Wait Reason” has the value 6 or 13, “waiting for a user request”. In an exemplary embodiment, the process counter “Thread State” should have the value “5”, and the process counter “Thread Wait Reason” should have either value “6” or “13”.

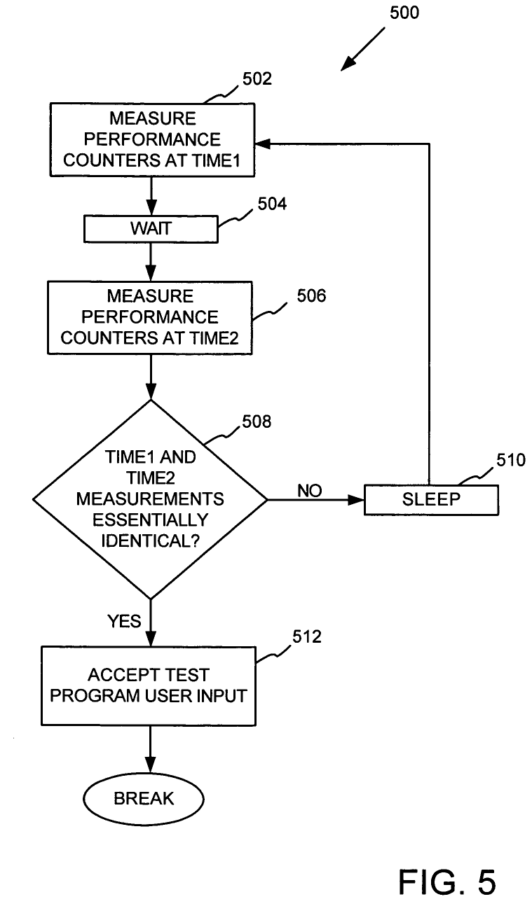

At process block 414, it is decided if the thread state could not be determined. If so, this section of the process is considered to have failed, and in some embodiments the process continues as shown at FIG. 5. The thread state cannot always be determined for a given thread. Sometimes, an operating system does not support this feature, other times, even though the operating system allows thread state questioning, a specific implementation does not support it, such as in the case of some terminal machines. If the thread state could be determined, the process is continued at process block 416, where the process sleeps.

At process block 418, the requested action is performed on the target UI element. In an exemplary embodiment, the action entails selecting the UI element. If an error condition results—if an exception is thrown—then the action has failed. If no error condition occurs, then the action has succeeded and the process ends. It should be apparent to those skilled in the art that the flowchart in FIG. 4 is not the only way to perform the given process, and is for illustrative purposes only. For example, certain acts described may be omitted in particular embodiments, and certain acts may be performed in an order different than that shown. For instance, and without limitation, the if the window is enabled (404), if the window has foreground focus (408) and if the thread is in a wait for user input state (412) can be performed in a different order.

The process shown in FIG. 4 is successful, in some implementations, about 80% of the time; that is, 20% of the time the element still fails, at process block 418, to process the user action. Though the reasons for such failures are very difficult to determine, often failure occurs because the exemplary process detailed in FIG. 4 synchronizes with the foreground thread but not with background threads, which might also be interacting with the element. It is both difficult and time consuming to synchronize the process in question with all background threads; the reasons why are numerous, but to give an example, in some operating systems some threads are always busy, and therefore, these threads are unavailable for synchronization.

To decrease the failure rate, an exemplary method 500 shown in the flowchart of FIG. 5 can be utilized. The exemplary method 500 represents a particular embodiment that expands the exemplary methods described above and should not be construed as limiting in any way. Instead, the method may be modified in arrangement and detail without departing from the scope of the disclosed technology. For example, certain acts described may be omitted in particular embodiments.

In an exemplary embodiment, if the “getting thread state” at process block 414 fails, performance counters are measured to determine when a UI element will be ready to perform an action. In other embodiments, performance counters are measured without performing the processes detailed in FIG. 4. In yet other embodiments, performance counters are measured prior to performing the processes explained in FIG. 4. Other possible embodiments are also envisioned.

To measure performance counters, two readings of certain performance counters (502) are taken with a time Δ between the two readings. Which performance counters to measure is implementation dependent, but generally, suitable performance counters are those associated with the memory and CPU consumption by the target process. Sample suitable performance counters are the CPU cycles for the target UI control, or some other measure of the process activity. Specific operating systems may provide suitable performance counters.

At process block 502, a first measure of the performance counters is taken. At process block 504, the process sleeps until some time has passed, some event occurs or, in some embodiments, it returns immediately. This process block is explained with more detail in FIG. 7. In an exemplary embodiment, the process sleeps for some period of time. The length of time to sleep is implementation dependent, but should not be so short that the performance counters do not have time to change, nor should it be so long that the running time of the process as a whole is compromised. Each separate instantiation of the performance counter measurement may have its own designated wait state. If a sleep time is chosen, the specific time to sleep may be dependent on the type of UI item, the type of computer used, or another method of determining the specific time to wait between performance counter measurements may be chosen.

At process block 506, a second measure of the same performance counters is taken. At process block 508, it is determined if the two readings are essentially identical, as explained below. If so, then it is assumed that the target process is ready for user input. If the two performance counters' measurements are too far apart, then, at process block 510, the test program sleeps. As mentioned, a more complete explanation of the sleep process is given with reference to FIG. 7.

At process block 502, the process checks the performance counters again. This process continues until either the two performance counter readings are essentially identical or until a user-defined time-out criterion is reached, discussed with reference to FIG. 7. Two counter readings are essentially identical when their values are sufficiently close to indicate that the target process is not engaged in other activity. The exact amount of difference between the two readings allowed is implementation-dependent.

After two essentially identical performance counter readings are found, at process block 512, the program again attempts to select the UI element.

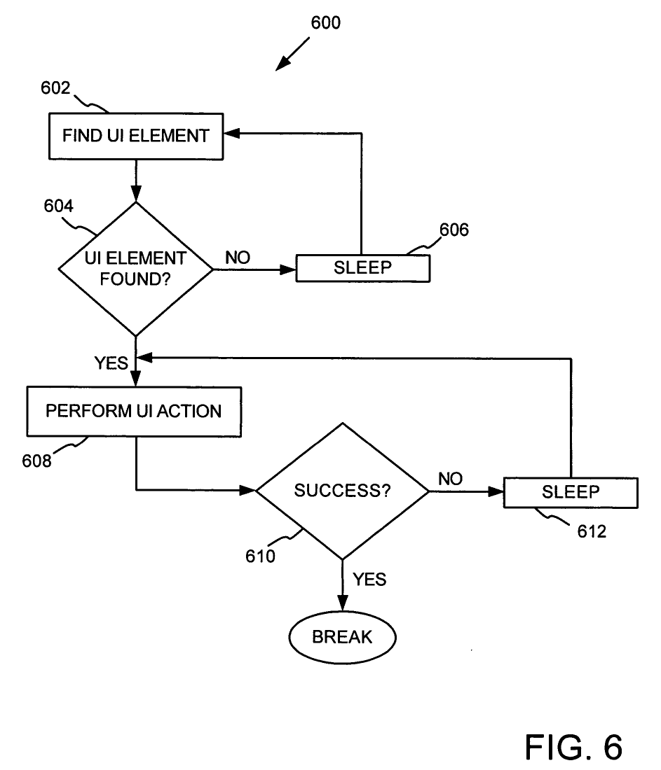

To improve the performance to essentially 100%, an exemplary method 600 shown in the flowchart of FIG. 6 can be utilized. The exemplary method 600 represents a particular embodiment that expands the exemplary methods described above and should not be construed as limiting in any way. Instead, the method may be modified in arrangement and detail without departing from the scope of the disclosed technology. For example, certain acts described may be omitted in particular embodiments.

At process block 602, the UI element that is to have an action performed on it is located. At process block 604, it is determined if locating the UI element was successful. If not, then the process continues at process block 606, where the process sleeps for some period, and again tries to locate the element at process block 602. A more complete explanation of the sleep process is given with reference to FIG. 7.

Once the UI element is successfully located, the desired action is performed on the UI element, as shown at process block 608. Often, this entails the test automation program selecting the UI element. At process block 610, it is determined if the action completed successfully. If the action did succeed, then the method has successfully completed. If the action did not succeed, then the process continues at process block 612, where the process sleeps, and again attempts to perform the action. In an exemplary embodiment, the process sleep time is 500 ms. In an exemplary embodiment this approach is combined with those depicted on FIGS. 4 and 5.

An exemplary method of the sleep process block mentioned with reference FIGS. 4, 5, and 6 is more fully described with reference to FIG. 7. The exemplary method 700 represents a particular embodiment that expands the exemplary methods described above and should not be construed as limiting in any way. Instead, the method may be modified in arrangement and detail without departing from the scope of the disclosed technology. For example, certain acts described may be omitted in particular embodiments, or performed in a different order.

At process block 702, it is determined if some user-defined criterion has been met, if so then the process continues at process block 704. If not, the process continues at process block 706. Process block 702 is generally used to determine if the process has been waiting for too long a period for the requested action to happen.

In an exemplary embodiment the user-defined criteria asks if the total time waiting for this specific action has been 3 minutes or longer, if waiting for a window response; and 2 minutes or longer, if waiting for a window element response. Another embodiment counts the number of times that it has entered the sleep module and then throws an exception when a maximum number has been reached. In other embodiments the criterion is a total wait time. In yet other embodiments the criterion is the occurrence of an event; other possible criteria should be obvious to someone of skill in the art.

At process block 704, an exception is thrown—the program should handle it accordingly. If the user-defined criterion has not been met, the process continues at process block 706 where the program pauses; a number of pause criteria are acceptable. In some instances, as shown in process block 708, the program sleeps for some designated period of time. Ideal sleep time is dependent upon the underlying hardware, the specific application, and exactly what is being waited for; but a basic rule of thumb is that if the wait time is too small, the computer system is not given enough time to change state or the test program will be using too many CPU resources by performing too many checks, but if the wait time is too long, it can degrade application running time. In an exemplary embodiment, each invocation of the sleep time has at least the potential of being different.

In process block 710, the process waits until a certain amount of time expires or until some event occurs, whichever happens first. In process block 712, the process returns to the calling program immediately. Each of the choices in process block 706 may be invoked within the same application at different places, a single application may invoke only a subset of the choices, or a different method of determining sleep time may be used. After the sleep of whatever sort, at process block 714, control returns to the calling process.

The implementations described here are technology agnostic, in that they should be able to be built into the underlying applications at a low-enough level that the implementation is invisible to users of the automatic testing programs; objects are selected without any awareness of the underlying synchronization.

### Other Alternatives

Having described and illustrated the principles of the illustrated embodiments, it will be recognized that the various embodiments can be modified in arrangement and detail without departing from such principles. It should be understood that the programs, processes, or methods described herein are not related or limited to any particular type of computing environment, unless indicated otherwise. For example, the technologies described herein may be applied to any user interface function that needs synchronization with threads other than its own.

Various types of general purpose or specialized computing environments may be used with or perform operations in accordance with the teachings described herein. Elements of embodiments shown in software may be implemented in hardware and vice versa. Various types of general-purpose or specialized computers may be used to perform the systems and methods disclosed herein. Furthermore, computer-readable media comprising computer-executable instructions for performing such actions can achieve actions described herein.

In view of the many possible embodiments, it should be recognized that the detailed embodiments are illustrative only and should not be taken as limiting the scope of our invention. Rather, I claim as my invention all such embodiments as may come within the scope and spirit of the following claims and equivalents thereto.

I claim:

1. In a computer system, a method comprising:
A calling entity choosing a target element; the target element unable to directly synchronize with at least one background thread;
establishing at least one timeout criterion;
the calling entity invoking a target action to be performed on the target element;
a synchronizer attempting to perform the target action on the target element; and
the synchronizer returning control to the calling entity when either the target action is performed on the target element, or
the timeout criterion is met and a synchronization error condition is generated.

2. The method of claim 1, wherein the attempting to perform the target action comprises:
performing at least one of the following activities:
Activity 1: waiting until a window associated with the target element is ready for user input; and then attempting to perform the target action;
Activity 2: waiting until two readings of at least one performance counter associated with the target element are essentially similar; and then attempting to perform the target action;
Activity 3: waiting until the thread associated with the target element is in a correct state, and then attempting to perform the target action; or
Activity 4: repeatedly attempting to perform the target action on the target element until the target action is performed or the timeout criterion is met.

3. The method of claim 1, wherein the calling entity is a user test emulation program.

4. The method of claim 2, wherein waiting until a window associated with the target element is ready for user input comprises: waiting until the window associated with the target element has focus.

5. The method of claim 2, wherein waiting until a window associated with the target element to be ready for user input comprises: waiting for the window associated with the target element to be enabled.

6. The method of claim 2, wherein waiting until the thread associated with the target element is in a correct state comprises: waiting for the thread associated with the target element to be the foreground thread.

7. The method of claim 2, wherein waiting further comprises at least one of: sleeping for a user-defined time; sleeping until an event occurs; or returning immediately.

8. The method of claim 2, wherein the correct state is a wait state; the correct state further comprising a reason; and the reason comprising wait for user input.

9. The method of claim 1, wherein the target element is unable to directly synchronize with the at least one background thread because the at least one background thread is essentially always busy.

10. The method of claim 2, wherein the waiting until two readings of the same performance counters are essentially similar further comprises:
determining a first value of the at least one performance counter;
sleeping; and
determining a second value of the at least one performance counter.

11. The method of claim 2, wherein waiting until the thread associated with the target element is in a correct state comprises repeatedly attempting to find the target element.

12. The method of claim 2, wherein Activity 4 further comprises sleeping between repeated attempts to perform the target action.

13. The method of claim 1, wherein the target element is unable to directly synchronize with at least one background thread because the calling entity cannot access the at least one background thread.

14. The method of claim 7, wherein sleeping further comprises generating a synchronization error condition if the timeout condition has been met.

15. A storage medium having instructions therein for causing a computer to perform a user interface test method wherein an object used in the method is a programming entity that determines if a target element has performed a requested action, the method comprising:
a user emulation test program choosing a requested action to be performed on a target element, at least one background thread essentially always in a busy state;
repeatedly attempting to perform the requested action and checking if the requested action has been performed until either the requested action has been performed or an action timeout parameter is met;
if the action timeout parameter has been met, then generating an action timeout error message.

16. The storage medium of claim 15, further comprising:
waiting until a window associated with the target element is ready to accept user input;
attempting to perform the requested action;
if the attempt to perform the requested action fails, then repeatedly checking and comparing two time-separated measures of a performance counter until:
the two measures are substantially similar or
a performance timeout parameter is met.

17. The storage medium of claim 15, further comprising sleeping between successive checking and attempting to perform actions.

18. A computer system comprising:
memory and a central processing unit executing a user interface tester program for testing a user interface;
a target user interface element;
a target user interface element locator module;
a window ready for input module for determining if a window associated with the target user interface element is ready for input;
a sleeper module;
a performance counters measurer, which determines if two performance counters' values associated with the target user interface element are substantially similar;
a requested action determiner, which determines if a requested action performed by the tester program on the target user interface element has been successful; and
a synchronization error message generator.

19. The computer system of claim 18 wherein the sleeper pauses for at least one of: a specified time, until a specified event occurs, or returns immediately.

20. An apparatus for ensuring that a user interface object has performed an action requested from a user test entity comprising:
means for accepting input from a user emulation test program;
means for establishing a timeout criterion;
means for performing a requested action on a user interface object;
means for determining that a window associated with the user interface object is ready for user input;
means for measuring a performance counter associated with the user interface object;
means for sleeping;
means for determining that a requested action on the user interface object has been performed; and
means for generating an error message indicating that an action was unable to be performed because the timeout criterion was met.
